(19) United States
(12) Patent Application Publication
(10) Pub. No.: US 2016/0271531 A1
(43) Pub. Date: Sep. 22, 2016

(54) Process and Apparatus for Recovering Valuable or Harmful Non-Aqueous Liquids from Slurries

(71) Applicant: PRIME SERVICES TRUSTEE LIMITED, Oakura, New Plymouth (NZ)

(72) Inventor: CRAIG NAZZER, Oakura, New Plymouth (NZ)

(73) Assignee: PRIME SERVICES TRUSTEE LIMITED, Oakura, New Plymouth (NZ)

(21) Appl. No.: 14/903,618

(22) PCT Filed: Jul. 11, 2014
(86) PCT No.: PCT/NZ2014/000143

§ 371 Date: Jan. 8, 2016

(30) Foreign Application Priority Data
Jul. 11, 2013 (NZ) 613116

(51) Int. Cl. B01D 29/90

(52) U.S. Cl. CPC B01D 29/906; B01D 29/904; B01D 35/20

(57) ABSTRACT

This invention relates generally to a process and an apparatus therefor for recovering valuable or harmful non-aqueous process liquids from mixtures or slurries that contain such liquids and solid particles. In a first aspect there is provided a filtration process for recovering a substantially non-aqueous process liquid from a feed slurry that predominantly comprises a mixture of the process liquid and solid particles, the process employing a sweep liquid that is less dense than the process liquid.

### FIELD OF THE INVENTION

This invention relates generally to a process and an apparatus therefor for recovering valuable or harmful non-aqueous process liquids from mixtures or slurries that contain such liquids and solid particles.

### BACKGROUND OF THE INVENTION

Many industrial and commercial processes utilise a valuable and/or potentially harmful process liquid that becomes mixed with finely divided waste solid matter. For commercial and environmental reasons it is desirable to recover this liquid before disposing of the waste matter. Many types of devices including gravity separators, cyclone separators, filters, clarifiers, centrifuges, and combinations thereof, are used for this purpose.

The simpler gravity separators typically yield a waste sludge or sediment that contains a significant amount of the original process liquid. This can lead to high loss of the process liquid in the waste sediment unless further steps are added to the process to recover process liquid from the sediment. Furthermore gravity is not always an effective driving force for separation if the particles are very fine and remain suspended without settling in a timely manner.

Filters and centrifuges are typically able of recover a higher fraction of the original process liquid than gravity type separators. Filters are often preferred because they are generally simple and compact, and less costly than centrifuges. In a filter the solid particles typically accumulate in a wet filter cake.

A major drawback of filtration systems in which a filter cake is formed is the reduction in flow as the filter cake builds in thickness. As more solids-contaminated liquid flows through the filter medium, the filter cake becomes thicker, resulting in higher resistance to the flow of the fluid through the filter. The pressure must then be increased (or the filtration area increased) to maintain a high flow rate, however increasing the pressure in a filter increases costs and potential hazards, and may not be desirable or feasible. In response to this problem the filtering process is typically periodically interrupted to remove the filter cake and then resume filtration. The cake is often removed by scraping, shaking, flushing or using reverse flow to push the filter cake off the filter medium, e.g., via a backwash, backflow, gas pulse, etc.

Alternatively, many filters have disposable elements such as cartridges that are replaced when caked with solid matter.

In basic filtration, in the absence of further improvements, the liquid contained in the filter cake has essentially the same composition as the original liquid that entered the filter. For water miscible process liquids a washing step using water is commonly added to remove a portion of the process liquid from the filter cake. This is typically less feasible when the process liquid is non-aqueous. In any case with any type of washing the commonly known drawbacks include uneven distribution and flow of wash liquid through the filter cake, excessive consumption of wash liquid and dilution of the process liquid that is recovered in the filtrate. Furthermore when a back wash is used to unclog a filter medium or when washing liquid is used to sluice out the solid matter or to clean critical surfaces before moving to the next step in the separation process then some of the valuable or harmful process liquid may be swept into highly diluted waste streams from which it is often overly expensive to recover the residual valuable or harmful liquid. Overall, although a large fraction of the original liquid is recovered by modern filtration systems, the waste matter still typically contains a significant quantity of the original liquid. If the original liquid is valuable or potentially harmful then costs increase and there may be greater HSE risks.

One common solution for non-aqueous organic process liquids is to destroy the organic content of the waste material, e.g. by incineration, thermal oxidation, etc. This approach adds complexity, adds cost to comply with air emission regulations, possibly increases safety and environmental hazards, and results in total loss of the residual process liquid.

Because of the above noted drawbacks, including lost process liquid and potential for HSE harm, there is a need for processes to that improve the degree of separation of valuable or harmful process liquids from slurries containing waste solids, thereby enabling greater recovery and reuse of these valuable or harmful process liquids. In particular, there is a need for improvements in the performance of filtration equipment and systems.

It is an object of the present invention to overcome some of the above-mentioned difficulties, or to at least provide the public with a useful alternative.

The present invention provides a straightforward means of separating non-aqueous process liquids from mixtures containing these liquids and dispersed solid matter. This allows the harmful and/or valuable liquid components to be recovered and made available for reuse or recycling by the operator.

Related processes and apparatuses for recovering aqueous process liquids are described in PCT/NZ2013/000019 filed 25 Feb. 2013, which is incorporated by reference herein in its entirety.

### SUMMARY OF THE INVENTION

In a first aspect there is provided a filtration process for recovering a substantially non-aqueous process liquid from a feed slurry that predominantly comprises a mixture of the process liquid and solid particles, the process employing a sweep liquid that is less dense than the process liquid and including the steps of:
(a) introducing the feed slurry into a reservoir above a substantially horizontal filter medium therein and wherein the filter medium is adapted and dimensioned to allow liquids to flow through it in use while blocking the passage of most or all of the solid particles in the feed slurry through the filter medium; and
(b) introducing the sweep liquid into the reservoir above the filter medium in such a manner so as to create a layer of the process liquid between the less dense sweep liquid above and the filter medium below, thereby creating a horizontal interface zone between the sweep liquid layer and the process liquid layer; and
(c) pressurising the liquid layers above the filter medium to a pressure that is higher than the pressure acting beneath the filter medium, such that the difference between the two pressures is sufficient to cause liquid to flow through the filter medium, thereby drawing the interface zone between the sweep liquid layer and the process liquid layer towards the filter medium; and
(d) agitating by an agitation means a portion of the liquid that is in close proximity to and above the filter medium so as to impede or prevent the excessive accumulation of solid particles on the surface of the filter medium, wherein the agitation means is adapted and dimensioned to avoid excessive mixing of the sweep liquid and the process liquid; and
(e) allowing the flow of liquid through the filter medium in step (c) and the operation of the agitation means in step (e) to continue until a portion of the process liquid has been displaced out of the slurry through the filter medium thereby forming a depleted slurry above the filter medium.

In one embodiment, the process further includes the step of removing at least a portion of the filtrate from the reservoir.

In another embodiment, the process further includes the step of removing at least a portion of the depleted slurry from the reservoir.

In another embodiment, the agitation step (d) is performed using an agitation means that includes one or more stirring blades that move in a substantially horizontal plane through at least a portion of the liquid layer that is above and in close proximity to the top surface of the filter medium.

In one further embodiment, the process further includes the step of adding a dispersing agent to the feed slurry or to the liquid in the reservoir above the filter medium.

In another embodiment, the process further includes the step of adding additional sweep liquid to the sweep liquid layer in the reservoir after the addition of the feed slurry by a method that does not cause excessive persistent mixing of sweep liquid and process liquid.

In the aspect and embodiments defined above the process liquid in the feed slurry is selected from crude oil; slop oil; bunker oil; fuel oil; gasoline; diesel; kerosene; bio-diesel; synthetic oil; organic solvents; coolants and cutting fluids used in metal cutting and metal forming; liquids used in solvent extraction; mineral processing and metal refining; mother liquors in crystallisation processes; ionic liquids; drilling, fracking and completion fluids used by the oil and gas industry; automotive and aircraft fluids; heat transfer fluids; hydraulic fluids; lubricating oils, liquids used during the manufacture of cosmetics, pharmaceuticals, plastics, other petrochemicals, and electronics, toxic industrial liquid effluent.

In the aspect and embodiments defined above, the sweep liquid comprises natural gas liquids, gasoline; diesel; bio-diesel; an alcohol; acetone or other solvent; or a mixture thereof.

In one embodiment the process further includes the step of separating and recovering sweep liquid from at least a portion of the depleted slurry removed from the reservoir.

In another embodiment the process further includes the optional step of applying vibrations including ultrasonic vibrations to the slurry above the filter medium wherein in use the vibrations aid the separation of process liquid from the surfaces of the solid particles.

In another aspect the present invention provides an apparatus that is suitable for recovering process liquid from a feed slurry that predominantly comprises a mixture of the process liquid and solid particles, the apparatus including:
(a) a reservoir suitable for holding the process liquid, a sweep liquid and feed slurry and operating at the required pressures, and;
(b) a substantially horizontal filter medium mounted in the reservoir so as to create within the reservoir an upper chamber bounded on its lower side by the filter medium and a lower chamber bounded on its upper side by the filter medium, wherein the filter medium blocks the passage of most or all of the solid particles in the feed slurry from the upper chamber to the lower chamber but allows liquids to flow through it from the upper chamber to the lower chamber, and;
(c) a feed slurry inlet means through which feed slurry enters the upper chamber, and;
(d) a sweep liquid inlet means through which the sweep liquid enters the upper chamber, and;
(e) a filtrate outlet means through which filtrate flows from the lower chamber out of the reservoir, and;
(f) a slurry outlet means through which slurry flows from the upper chamber out of the reservoir, and;
(g) pressure connections and sources of pressure and/or vacuum connected thereto such that in use the pressure in the upper chamber is sufficiently higher than that in the lower chamber so as to cause liquid to flow downwards through the filter medium, and;
(h) an agitator means that agitates a portion of the liquid that is in close proximity to and above the filter medium so as to impede or prevent the excessive accumulation of solid particles on the surface of the filter medium, wherein the agitation means is adapted and dimensioned to avoid excessive mixing of the sweep liquid and the process liquid.

In another aspect the present invention provides an apparatus for recovering one or more non-aqueous process liquids from a feed slurry that comprises one or more non-aqueous process liquids and solid particles; the apparatus comprising:
a) a reservoir which is adapted to accept and hold a sweep liquid and feed slurry, wherein the sweep liquid is less dense than and substantially miscible with the process liquid, wherein the feed slurry comprises a mixture of the process liquid and solid particles, and;
b) a substantially horizontal filter medium within the reservoir which is adapted and dimensioned to allow liquids to flow through it in use while blocking the passage of most or all of the solid particles in the feed slurry through the filter medium, and;
c) a pressurising means which is adapted to provide a pressure difference across the filter medium where the pressure above the filter medium is higher than the pressure acting beneath the filter medium, the pressure difference being sufficient to cause the liquid to flow through the filter medium, thereby drawing the interface region between the sweep liquid layer and the process liquid layer towards the filter medium when the apparatus is in use, and;
d) an agitation means which is adapted to agitate a portion of the liquid that is in close proximity to and above the filter medium so as to impede or prevent the excessive accumulation of solid particles on the surface of the filter medium, wherein the agitation means is adapted and dimensioned to avoid excessive mixing of the sweep liquid and the process liquid, and;
e) a first outlet means adapted to allow liquid filtrate to exit the reservoir, and;
f) optionally a second outlet means adapted to allow slurry or sediment formed above the filter medium to exit the reservoir, such slurry or sediment substantially comprising the sweep liquid and the solid particles from the feed slurry.

In one embodiment the agitation means of each apparatus defined above includes one or more stirring blades that move in a substantially horizontal plane through at least a portion of the liquid layer that is above and in close proximity to the top surface of the filter medium.

These and other aspects of the present invention will become apparent from the following description.

### BRIEF DESCRIPTION OF THE DRAWING

The invention will now be described by way of example only with reference to the figure where:

FIG. 1 illustrates a filtration apparatus for undertaking a process defined in this specification for separating and recovering non-aqueous process liquid from a feed slurry that comprises a mixture of solid particles and the process liquid by using a sweep liquid that is less dense than the process liquid to displace at least a portion of the process liquid out of the feed slurry while applying agitation to promote high filtrate flow rates thereby efficiently creating a resultant depleted slurry that is predominantly comprised of solid particles and sweep liquid and is depleted of process liquid.

### DETAILED DESCRIPTION OF THE INVENTION

The following is a description of the present invention, including particular embodiments therefor, given in general terms. The invention is further elucidated from the disclosure, which supports the invention and specific illustration thereof.

Throughout the specification, and any sections that follow, unless the context requires otherwise, the words “comprise”, “comprising”, and the like, are to be construed in an inclusive sense as opposed to an exclusive sense, that is to say, in the sense of “including but not limited to”.

Definitions:

The term “about” as used herein in connection with a referenced numeric indication means the referenced numeric indication plus or minus up to 10% of that referenced numeric indication. For example, the language “about 50” units covers the range of 45 units to 55 units.

The term “feed slurry” as used herein means the mixture of solid particles and liquids that is treated by this invention, wherein the liquid part is termed the “process liquid” and is comprised of one or more substantially non-aqueous liquids or a solution thereof, and includes miscible diluting agents if present and dissolved solids if present. By way of example only in a feed slurry comprised of solid particles and a solution of several miscible oils, a miscible solvent, and dissolved salt, the solution of several miscible oils, a miscible solvent, and dissolved salt is the process liquid.

The term “filter medium” as used herein means the sheet, plate, membrane, layer or layers of solid material or the like, that is suitably porous so that it blocks the passage of most or all of the solid particles in the feed slurry while allowing liquid to flow through it provided there is enough pressure difference across the filter medium to overcome resistance to the flow of the liquid through the filter medium. The term “filter medium” also includes sealing means as required to prevent leakage of slurry around the filter medium thereby ensuring that all liquid that flows from the upper chamber in the reservoir to the lower chamber passes through the filter medium.

The term “sweep liquid” as used herein means the liquid that is used to displace the process liquid out of the feed slurry above the filter medium and is less dense than the process liquid and is at least partially miscible with the process liquid.

The term “interface zone” as used herein means the liquid zone separating the sweep liquid layer and the process liquid layer below it.

The term “substantially horizontal” as used herein means either horizontal or having a degree of slope or angle that does not significantly impair the performance of the process or apparatus of the invention.

The term “predominantly comprised” as used herein means more than about 80% comprised.

The term “persistent” as used herein means lasting longer than about 24 hours.

The term “in close proximity to” as used herein means within about 50 mm thereof.

The term “filter cake” as used herein means an accumulation of solid matter on a filter medium that is sufficiently thick and/or densely packed so as to cause a significant increase in the resistance to filtrate flow through the filter medium.

The term “depleted slurry” as used herein means the slurry that is predominantly comprised of sweep liquid and solid particles that forms above the filter medium as a consequence of carrying out the sweep phase of the invented process of the invention as described herein.

The term “excessive” as used herein means high enough or large enough or severe enough to cause a significant degradation in the performance of the process or apparatus of the invention.

The term “agitator means” as used herein includes, but is not limited to a blade assembly comprising one or more substantially horizontal blades that when in motion imparts turbulence to at least a portion of the liquid above the filter medium.

As will become apparent from the description the invention has wide ranging utility, for example, in the recovery of valuable or harmful liquids from sediments and slurries that are generated during the following: crude oil storage, slop oil treatment, recycling used engine oil; metal or machining liquids, ionic liquid processes, production of solid products by precipitation or crystallisation, coolants and cutting fluids used in metal cutting and metal forming; liquids used in solvent extraction mineral processing and metal refining; non-aqueous mother liquors in crystallisation processes; drilling, fracking and completion fluids used by the oil and gas industry; automotive and aircraft fluids; heat transfer fluids; hydraulic fluids; lubricating oils; liquids used to manufacture cosmetics, pharmaceuticals, plastics, other petrochemicals, and electronics; toxic industrial liquid effluent and many other activities.

In these activities, the solid matter is typically composed of any one or more of: sand, silt, clay, limestone, sandstone, shale, proppant, ceramic, metal swarf, small metal particles, spent catalyst, rust, oxides, carbonates, hydroxides, sulfates, silicates, and crystals. Solid matter may include forms of valuable products produced as small particles.

The liquids in which these solids are dispersed are known as process liquids. Examples of process liquids with solid particles include: crude oil, e.g., crude oil in slop tanks or storage tanks, organic or synthetic drilling mud, heavy bottoms liquids, e.g., liquids in oil refinery distillation columns, processed oil, for example, oil produced in tar sand processing, organic liquids, e.g., liquids used during the production of petrochemical or pharmaceutical products, liquids in petrochemical plants, e.g., liquids that are contaminated by particles of spent catalysts, organic flowback fluids, e.g., fluids from oil or gas well drilling sites, hydraulic bearing lubricants, hydraulic power fluids, power transmission fluids, liquids collected from metal machining operations, heat transfer fluids, e.g., fluids that flow through corroded piping or other equipment, liquids collected when scale is removed from the inside of pipes or other equipment, and so on. Many of the liquid components in these process liquids are substantially non-aqueous, and valuable and/or harmful to the environment.

According to the invention, the selected sweep liquid is less dense than the process liquid. The sweep liquid is preferably a liquid that is low cost, safe to use, and readily available. This makes the invention useful for a wide range of operators.

A large proportion of non-aqueous process liquids are lighter than water, e.g., many oils and other organic liquids. Hence, water cannot be used as a sweep liquid in these situations. However, there is a wide range of inexpensive, commonly used, chemically benign, light oils that are substantially less dense and less viscous than many non-aqueous process liquids. Examples include natural gas liquids and other light hydrocarbon liquids such as light alkanes. A particular example is hexane. These light oils are substantially miscible with a wide range of organic process liquids. The invention's use of gravity to maintain separation of miscible liquids provides a marked improvement over current separation technology. Using standard technology, only non-miscible liquids are easily separated by gravity, while miscible liquids are deemed inseparable except by energy intensive expensive processes such as distillation.

According to the invention, the solid particles in the feed slurry are of types and sizes such that they settle slowly or remain in suspension for a long time. Alternatively, if they settle rapidly, then they are easily dispersed again by mechanical agitation, as described herein. Furthermore, the solids do not form lumps or agglomerations. However, if they do, then these lumps or agglomerations are easily broken down into finely divided particles by mechanical agitation, as described herein.

A wide range of sweep liquids is possible, and the operator may select a sweep liquid that suits the particular properties of the feed slurry. The selected sweep liquid should be less dense than the feed slurry and the process liquid within it. In many cases, the sweep liquid is substantially less viscous than the process liquid. This facilitates easier and faster separation of solid matter from the sweep liquid. For example, a light alkane can be selected as the sweep liquid when treating crude oil, dirty oil streams in oil refineries, used engine oil, or oil based drilling mud.

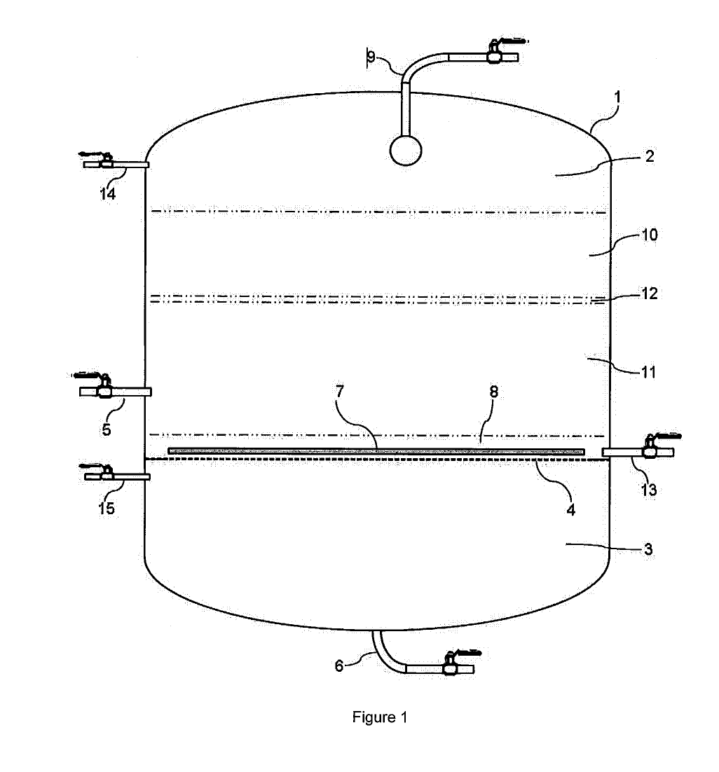

With reference to FIG. 1 the reservoir (1) contains an upper chamber (2) and a lower chamber (3) that are separated by a filter medium (4) that is mounted in a substantially horizontal plane across the reservoir. In the first embodiment, the feed slurry enters the upper chamber via the feed slurry inlet (5). The upper chamber is bounded on its lower side by the filter medium. The filter medium in turn forms the upper side of the lower chamber. The filter medium allows liquid to flow through it from the upper chamber to the lower chamber but blocks the passage of most or all of the solid particles that are in the feed slurry.

After at least a portion of the feed slurry has entered the upper chamber the next phase of operation of the invention, termed thickening, begins by applying a pressure to the upper chamber and a lower pressure to the lower chamber such that the difference between the two pressures is sufficient to cause liquid to flow from the upper chamber through the filter medium and into the lower chamber. Liquid that enters the lower chamber exits the lower chamber through the filtrate outlet (6). The agitator (7), which includes a number of substantially horizontal blades, is operated to cause the blades to move in a substantially horizontal plane in close proximity to the top surface of the filter medium. The agitator motion creates a turbulent zone (8) in the liquid close to the filter medium and promotes and/or prolongs the suspension of the particles in the slurry above the filter medium, thereby impeding or preventing the accumulation of solid particles on the filter medium, which in turn impedes or prevents the formation of a filter cake, which in turn avoids the significant drop in filtrate flow that would otherwise occur if a filter cake is allowed to form. During the thickening phase the agitator is operated at high speed to maximise flow through the filter medium but not at an excessive speed that might cause excessive attrition or breakage of the solid particles into smaller particles that could pass through the filter medium.

The thickening phase of operation continues until the desired solids content in the thickened slurry is reached. The desired solids content is preferably at least 10 wt % meaning at least 100 g of solid particles per kg of slurry, and more preferably at least 25 wt % meaning at least 250 g of solid particles per kg of slurry.

When the desired solids content in the slurry is reached the thickening phase is stopped by turning off the flow of feed slurry into the upper chamber, and the sweep phase of operation begins by adding sweep liquid into the upper chamber above the level of the process liquid. The sweep liquid is sprayed into the upper chamber so that it gently settles on top of the process liquid with only a small degree of mixing between the sweep liquid and process liquid. As shown in FIG. 1 by of example only, this can be achieved if the sweep liquid flows through a sweep liquid inlet assembly (9), comprising a pipe, valve and spray head in the upper part of the upper chamber. The spray head distributes the sweep liquid in a fine spray that settles on top of the process liquid layer with minimal mixing. The added sweep liquid thereby forms a sweep liquid layer (10) on top of the process liquid layer (11) in the upper chamber, with a narrow interface zone (12) between the sweep liquid and the process liquid layers. The speed of the agitator is then adjusted if necessary to avoid excessive vertical turbulence that could cause unwanted mixing between the sweep liquid and process liquid.

Filtration and agitation continue and the interface zone consequently descends as more and more process liquid below the interface zone flows through the filter medium. The average concentration of solid particles in the process liquid consequentially increases. However, the slurry in the upper chamber cannot pack down into a dense layer and therefore remains loose and free flowing. The interface zone descends into the slurry in the upper chamber thereby evenly displacing process liquid downwards out of the slurry without channelling because the slurry is a loose free flowing mixture of solid particles and liquid, unlike the filter cake in a conventional filter. The interface zone continues to descend as more process liquid is displaced downwards through the filter medium.

A benefit of the agitation is that by suspending most, if not all, the solid particles, the surfaces of the particles are more exposed to contact with the descending sweep liquid thereby helping to push or sweep process liquid off the surfaces of the solid particles. This is substantially different from the designs applied in many conventional filtration systems that use cake washing. In these conventional systems process liquid can become trapped and unreachable by the washing liquid in dense regions of the cake. Cracks can also be present in the cake, through which the wash liquid may prefer to flow, thereby bypassing large parts of the cake. Thirdly the cake may have uncontrollable variations in thickness and permeability that lead to uneven washing. Fourthly, where filter aid has been used, the increase in solid matter due to the filter aid increases the number of sites where process liquid can be trapped. Finally, when wash liquid is first introduced it may not always be evenly distributed across the filter cake. These problems are typically well known by filtration system designers and operators.

In one embodiment a dispersing agent may be used instead of or in addition to the agitation as a particle suspension means. It is anticipated that by using a suitable dispersant in the invention it would be possible to reduce the degree of agitation required because the dispersant is likely to impede or prevent the formation of a filter cake. It is further anticipated that the addition of a dispersing agent in some applications will be sufficient to hold the particles in a loose suspension which the descending front of sweep liquid can penetrate evenly without channelling. Additionally, with the agitator turned off or only running slowly there will be higher risk of clogging the filter but less persistent mixing of sweep liquid with process liquid.

In one embodiment the process further includes the optional step of applying ultrasonic vibrations to the slurry wherein in use the ultrasonic vibrations aid the separation of process liquid from the surfaces of the solid particles.

The sweep phase continues noting that by the time the interface zone penetrates the turbulent zone most of the process liquid has been recovered and substantially all of the remaining process liquid is in the turbulent zone while substantially all of the other liquid in the upper chamber is sweep liquid. Filtration can continue noting that the sweep liquid that enters the turbulent zone is thoroughly mixed with the process liquid therein, hence further reductions in process liquid content in the slurry occur by dilution rather than displacement. However, the dilution described above applies to the small amount of process liquid that is in turbulent zone, which is a small fraction of the total amount of process liquid treated by the process and apparatus of the invention. Hence, even if the process liquid and sweep liquid are wholly miscible in each other, the degree of overall dilution of process liquid by sweep liquid is very low and significantly lower than what is typically achieved when using the prior art.

During the sweep phase more sweep liquid can be added above the interface zone if required. The sweep phase continues until the desired amount of process liquid has been recovered in the filtrate. At the end of the sweep phase the slurry, termed “depleted slurry”, which has consequentially formed in the upper chamber above the filter medium is predominantly comprised of sweep liquid and solid matter. The depleted slurry can then be removed from the upper chamber through the slurry outlet (13) noting that it is free flowing and typically flows out easily especially with the help of the moving agitator, even if there is not much pressure in the upper chamber. If necessary more sweep liquid or a compatible wash liquid can be added to help sluice or flush out the depleted slurry.

During the thickening and/or sweep phases of operation pressure can be applied to the upper chamber by connecting a pressure source such as a pressurised gas to the upper chamber pressure inlet (14) and leaving the lower chamber unpressurised. Alternatively a second source of pressure that is lower than the pressure acting on the upper chamber can be connected to the lower chamber pressure inlet (15) to help push filtrate out of the reservoir. Alternatively a vacuum can be applied to the lower chamber. In all cases filtration is only possible if the pressure acting on the upper side of the filter medium is sufficiently higher than the pressure acting on the lower chamber to cause liquid to flow through the filter medium. It may be possible in some application to use only the head of liquid in the upper chamber on its own or combined with a vacuum connection to the lower chamber to generate enough pressure difference to achieve satisfactory filtration. It would be clear to someone skilled in the art how to optimise the pressure difference in any given situation. The optimal pressure difference would depend on many factors, including the physical properties of the reservoir and the nature of the process liquid, sweep liquid, the filter medium, the wt % of the solid particles in the process liquid and the like.

In a second embodiment, the feed slurry has a sufficiently high solids content without thickening to warrant omitting the thickening phase and proceeding to the sweep phase from the start. In this case one option is to start by partially filling the upper chamber with sweep liquid and then introducing the feed slurry into the upper chamber under the sweep liquid. As more feed slurry is added the sweep liquid rises and a layer of sweep liquid is created sitting on top of a layer of process liquid. Alternatively, some or all of the feed slurry can flow into the upper chamber initially and sweep liquid can be sprayed on top of the feed slurry as described above for the first embodiment. When the desired starting quantity of feed slurry and sweep liquid have been added the pressurising, filtration and agitation can proceed as described above for the sweep phase in the first embodiment.

In a further embodiment a back wash step can be added during or after the sweep phase whereby sweep liquid is introduced into the lower chamber such that its level rises up to the underside of the filter medium. As more sweep liquid is added, it passes upwards through the filter medium which can be useful to unclog the filter medium. This step is initiated preferably when the lower chamber is substantially full of filtrate such that there is only a small gap between the top of the filtrate layer and the underside of the filter medium. The sweep liquid, being less dense than the filtrate because the filtrate is primarily comprised of process liquid, thereby floats in a thin layer on top of the filtrate. As more sweep liquid is introduced the sweep liquid rises up and through the filter medium to perform the backwash step described above. However the process and apparatus of the invention enables this to be done with substantially less back wash liquid, in this case sweep liquid, being needed because the filtrate substantially fills the lower chamber and only a thin layer of backwash liquid is required to float on top of the filtrate layer, as described above.

In some applications it may be possible to thicken the original feed slurry using other methods and equipment that do not form part of this invention e.g. conventional cross flow filters or clarifiers and the like. The thickened slurry produced by these other methods and equipment can then be treated to recover process liquid by using this invention, in particular the sweep phase and subsequent steps as described in this specification. However, to avoid the need for additional equipment and as described in the first embodiments above, the entire process including thickening can be carried out in the apparatus of the invention.

If the sweep liquid is valuable or potentially harmful it may be unacceptable to dispose of the depleted slurry as is due to cost, or health safety and environmental concerns, in which case the process can be further adapted to include a depleted slurry treatment phase to remove sweep liquid from the depleted slurry.

If the sweep liquid is less dense than water then one option for the depleted slurry treatment comprises placing water and at least a portion of the depleted slurry into a vessel and allowing the sweep liquid to float in a layer on top of the water. The solid particles sink in the water to form a sediment or slurry that is depleted of sweep liquid. Sweep liquid can then be recovered from the layer of sweep liquid floating on the water.

If the sweep liquid is at least partially miscible with water and less dense than water then an alternative treatment comprises allowing the depleted slurry to enter a vessel that is partially filled with water in a manner that allows the sweep liquid to float in a layer on top of the water with minimal mixing between the sweep liquid and the water. The solid particles sink out of the layer of sweep liquid and into the underlying layer of water. Sweep liquid can then be recovered from the layer of sweep liquid floating on the water.

Alternatively or as a supplementary step added to either of the two above described depleted slurry treatment methods, water can be introduced below the depleted slurry such that the rising level of water lifts at least a portion of the sweep liquid out of the depleted slurry. The end result is similar to the above described results, namely that the sweep liquid collects in an upper liquid layer floating on the water from which at least a portion of the sweep liquid can be recovered.

In applications with oil based or oil like process liquids there are typically many options for the selection of a sweep liquid that has a density below that of the oil based or oil like process liquid being recovered. In these applications it may be possible to select a potentially effective sweep liquid from the following list: natural gas liquids and individual components thereof; gasoline; kerosene; diesel; bio-diesel; other light hydrocarbon liquids that are typically extracted from crude oils during refining; acetone and other common solvents; methanol, ethanol and other alcohols. Some of the liquids in the above list have potentially attractive properties for use as a sweep liquid, including; low density, low viscosity, low cost, and ready availability. For example low density, low viscosity light hydrocarbon liquids are readily available at refineries. The low density and low viscosity both help the sweep liquid to displace the heavier more viscous process liquid out of the slurry above the filter medium. These same properties then promote better and faster separation of the solid particles from the sweep liquid in the depleted slurry treatment phase. It would be clear to someone skilled in the art how to select the sweep liquid to optimise the process.

In many applications it may be important to fully decontaminate the solid matter that is in the feed slurry. For example the solid matter may be valuable necessitating decontamination irrespective of what process is used for treating the feed slurry. The process and apparatus of the invention provide an advantage in this regard by enabling the decontamination of the solid matter to be done within the apparatus of the invention, thereby avoiding further treatment. In other applications the solid matter may be a waste material but its disposal is constrained due to health safety and environmental concerns relating to residual liquid that may be on the surfaces of the solid matter. The process and apparatus of the invention provide an advantage in this regard by enabling the decontamination of the solid matter to be done within the apparatus of the invention, thereby avoiding or simplifying further treatment of the waste material.

In these and other applications it may be desirable to select the sweep liquid components from a list of liquids that, for the particular application under consideration, have one or more attractive properties which may include low density, low viscosity, low surface tension, low or high boiling point, low health safety and environmental risks, low cost, compatibility with the process liquid, non-reactive, non-corrosive, and so on.

Preliminary experiments to test the invention have been performed with several types of process liquids. It has been observed that, when the feed slurry first enters the stripping vessel, it flows as a coherent stream. There is negligible mixing with the sweep liquid as it falls by gravity through the sweep liquid and onto the top surface of the filter medium. The feed slurry is denser than the sweep liquid above it, which is why it falls onto the filter medium and then spreads out over the length and breadth of the stripping vessel to form a horizontal layer below the sweep liquid. This is assuming there are no large holes in, or around the edges of, the filter medium.

The increasing volume of feed slurry displaces an equal volume of sweep liquid upwards with negligible mixing. This creates a well-defined rising interface between the feed slurry and the less dense sweep liquid above it. The interface rises and passes the feed nozzle. After this, the feed slurry entry flow rate can be increased without creating undue risk of mixing the process liquid into the sweep liquid. At the end of the feed step, the batch of feed slurry occupies a layer on top of the filter medium. There is a well-defined narrow interface zone between it and the upwardly displaced layer of sweep liquid.

The interface zone between the process liquid and the sweep liquid persists despite the substantial degree of miscibility between the sweep liquid and the process liquid. In experiments using appropriately selected sweep liquid and a range of different process liquids, the narrow interface zone has been clearly visible, and surprisingly robust and long lasting in the absence of strong vertical currents.

During or soon after the end of the feed step, the valve in the filtrate outlet is opened to allow the filtrate liquid in the bottom chamber below the filter medium to flow out of the stripping vessel. The valve in the pressure source line may be opened at this time to raise the pressure within the stripping vessel. The filtrate outlet may be connected to un-pressurised pipework. From this, a differential pressure is created across the filter medium and liquid begins to flow through the filter medium.

In one alternative, there is no external pressure source, and the driving force across the filter medium is created only by the head of liquid above it. In a further alternative, the filtrate outlet is connected to a vacuum source to increase the differential pressure across the filter medium. The edges of the filter medium form a seal with the internal walls of the stripping vessel such that essentially all liquid moving from above the filter medium to the bottom chamber below the filter medium must flow through the filter medium.

In commonly available filtration equipment, solid matter forms a filter cake on the surface of the filter. As the filter cake thickness increases, the resistance to flow increases. This reduces the flow of filtrate, assuming no change in the pressure difference across the filter. Filtration efficiency drops, and a typical response is to install a larger filter with more surface area and/or complex filter cleaning systems. Alternatively, differential pressure across the filter is raised so as to maintain high filtrate flow rates. This increases cost and complexity, and creates a more compacted filter cake. A compacted filter cake means that it is more difficult to extract process liquid from the filter cake, and more difficult to remove the filter cake from the filter medium for disposal.

The invention overcomes the above noted problems by avoiding the creation of a filter cake. This allows the apparatus to operate more efficiently, with significantly lower differential pressure and/or smaller filter area. A unique feature of this invention is the agitator located close to the top surface of the filter medium. The agitator creates turbulence in the fluid immediately above the filter medium. It substantially impedes the settling of the solid particles, and thereby avoids or minimises the formation of a filter cake.

In experiments to test the invention, it has been observed that agitation of a thin layer of fluid immediately above the top surface of the filter medium prevents the settling of small solid particles. This enables a higher flow rate of liquid through the filter medium. Moreover, the filter medium blocks the downward movement of solid particles. This, in turn, enables the sweep liquid above the process liquid to push the process liquid through the filter medium, thereby creating a slurry trapped above the filter medium that is depleted of process liquid. A further benefit of the agitation is that the solid matter remains suspended and is easier to flush out of the apparatus. From this, there is less risk of forming troublesome lumps or stiff sediment.

Surprisingly, it has been also observed that agitation can be relatively vigorous, which, although it may create waves in the interface zone between the sweep liquid and the process liquid to change shape, it does so without causing excessive mixing of the sweep liquid and the process liquid. This is a remarkable phenomenon. The lack of excessive mixing between the sweep liquid and the process liquid provides an important advantage, as it substantially reduces the total volume of sweep liquid needed to strip the process liquid from the feed slurry. In turn, this reduces the amount of sweep liquid that is mixed into the process liquid in the filtrate. This improves the quality of the filtrate.

The filtrate, containing the valuable or harmful non-aqueous process liquid from the feed slurry, flows out of the reservoir. The filtrate may flow from the lower chamber underneath the filter medium to a convenient location for further use or treatment by the operator. The removal of filtrate from the reservoir may be done in a controlled manner while each batch of feed slurry is processing. This may be done such that at the end of each batch operation the bottom chamber remains essentially full of filtrate. The filtrate may then exit the apparatus, to be replaced by filtrate from the next batch of feed slurry.

This invention differs from conventional multi-phase separators, e.g., oil/water separators, in which the liquids are non-miscible and of different densities. In these conventional separators, assuming no stable emulsion has formed, the non-miscible liquids will separate by gravity. For example, the oil will rise and float in a layer on top of the water. This occurs even if the components are mixed thoroughly beforehand. Thus, in conventional separators, the separation performance relies on the lack of miscibility. This is distinguished from the process of the present invention, which achieves high separation performance even if the sweep liquid and process liquid are fully miscible with each other.

The next step of the process of the invention is the removal of the slurry, which is now substantially comprised of solid particles and sweep liquid. Removal occurs by opening the valve in the slurry outlet (see FIG. 1). This slurry is depleted of process liquid. However, it has characteristics that enable rapid separation of sweep liquid using simple low cost processes.

For example, in the cases where the sweep liquid is a light alkane, such as hexane, the density would be about 0.7 g/ml and viscosity about 0.3 cP. The low density and low viscosity promote rapid separation of solid matter by settling. Light alkanes also float on, and are insoluble in, water. Hence, the slurry of light alkane sweep liquid and solid particles can simply flow from the reservoir to a tank containing water and in which the sweep liquid would float on the water. The solid matter can then separate from the sweep liquid and accumulate at the bottom of the tank, possibly with some of the solid matter dissolving in the water.

If the solid matter is non-hazardous, then the water and solid matter can be directly disposed of without further treatment, with negligible loss of either process liquid or sweep liquid. The sweep liquid can be skimmed from the surface of the water and reused in the apparatus that is shown in FIG. 1. Alternatively, if the sweep liquid is volatile, heat and/or a reduction in pressure can be applied to the slurry of sweep liquid and solid matter such that the sweep liquid vaporises, creating a dry clean waste solid matter ready for disposal. The vaporised sweep liquid can then be used as fuel or condensed and reused in the apparatus that is shown in FIG. 1.

Thus, when compared to previous devices and methods, the invention applies process steps and equipment details that are distinctive, either individually or when considered in combinations with one another.

The entire disclosure of all patent applications, patents, and publications cited herein are hereby incorporated by reference in their entirety.

While the invention has been described here, with reference to certain preferred embodiments, a person of ordinary skill in the art will recognise that many of the components and parameters may be varied or modified without departing from the scope of the invention. Furthermore, where known equivalents exist to specific features, such equivalents are incorporated as if specifically referred to in this specification.

In addition, it should be noted that titles, headings, and the like are provided to enhance the reader's comprehension of this document, and are not limiting to the scope of the present invention.

1. A filtration process for recovering a substantially non-aqueous process liquid from a feed slurry that predominantly comprises a mixture of the process liquid and solid particles, the process employing a sweep liquid that is less dense than the process liquid and including the steps of:
(a) introducing the feed slurry into a reservoir above a substantially horizontal filter medium therein and wherein the filter medium is adapted and dimensioned to allow liquids to flow through it in use while blocking the passage of most or all of the solid particles in the feed slurry through the filter medium; and
(b) introducing the sweep liquid into the reservoir above the filter medium in such a manner so as to create a layer of the process liquid between the less dense sweep liquid above and the filter medium below, thereby creating a horizontal interface zone between the sweep liquid layer and the process liquid layer; and
(c) pressurising the liquid layers above the filter medium to a pressure that is higher than the a pressure acting beneath the filter medium, such that the difference between the two pressures is sufficient to cause liquid to flow through the filter medium, thereby drawing the interface zone between the sweep liquid layer and the process liquid layer towards the filter medium; and
(d) agitating by an agitation means a portion of the liquid that is in close proximity to and above the filter medium so as to impede or prevent the excessive accumulation of solid particles on the filter medium, wherein the agitation means is adapted and dimensioned to avoid excessive mixing of the sweep liquid and the process liquid; and
(e) allowing the flow of liquid through the filter medium in step (c) and the operation of the agitation means in step (d) to continue until a portion of the process liquid has been displaced out of the slurry through the filter medium thereby forming a depleted slurry above the filter medium.

2. The process as claimed in claim 1 that further includes the step of removing at least a portion of the filtrate from the reservoir.

3. The process as claimed in claim 1 that further includes the step of removing at least a portion of the depleted slurry from the reservoir.

4. The process as claimed in claim 1 where the agitation step (d) is performed using an agitation means that includes one or more stirring blades that move in a substantially horizontal plane through at least a portion of the liquid layer that is above and in close proximity to the a top surface of the filter medium.

5. The process as claimed in claims 1 wherein the process further includes the step of adding a dispersing agent to the feed slurry or to the liquid in the reservoir above the filter medium.

6. The process as claimed in claim 1 wherein the process further includes the step of adding additional sweep liquid to the sweep liquid layer in the reservoir after the addition of the feed slurry by a method that does not cause excessive persistent mixing of sweep liquid and process liquid.

7. The process as claimed in claim 1 wherein the process liquid in the feed slurry is selected from one or more of the following: crude oil; slop oil; bunker oil; fuel oil; gasoline; diesel; kerosene; bio-diesel; synthetic oil; organic solvents; coolants and cutting fluids used in metal cutting and metal forming; liquids used in solvent extraction; mineral processing and metal refining; mother liquors in crystallisation processes; ionic liquids; drilling, fracking and completion fluids used by the oil and gas industry; automotive and aircraft fluids; heat transfer fluids; hydraulic fluids; lubricating oils, liquids used during the manufacture of cosmetics, pharmaceuticals, plastics, other petrochemicals, electronics; and toxic industrial liquid effluent.

8. The process as claimed in claim 1 wherein the sweep liquid comprises natural gas liquids, gasoline; diesel; bio-diesel; an alcohol; acetone or other solvent; or a mixture thereof.

9. The process as claimed in claim 3 wherein the process further includes the step of separating and recovering sweep liquid from at least a portion of the depleted slurry removed from the reservoir.

10. The process as claimed in claim 9 wherein the step of separating and recovering the sweep liquid from at least a portion of the depleted slurry removed from the reservoir includes placing water and the depleted slurry into a second reservoir to form a water layer into which at least a portion of the solid particles sink and a sweep liquid layer forms and floats on top of the water and from which at least a portion of the sweep liquid can be recovered.

11. The process as claimed in claim 9 wherein the step of separating and recovering the sweep liquid from at least a portion of the depleted slurry removed from the reservoir includes placing the depleted slurry into a second reservoir, adding sufficient water from beneath at least a portion of the depleted slurry in the second reservoir to lift at least a portion of the sweep liquid up out of at least a portion of the depleted slurry and into an upper liquid layer on top of the water that is predominantly comprised of sweep liquid from which at least a portion of the sweep liquid can be recovered.

12. The process as claimed in claim 1 wherein the process further includes the step of applying vibrations including ultrasonic vibrations to the slurry above the filter medium wherein in use the vibrations aid the separation of process liquid from the surfaces of the solid particles.

13. A filtration apparatus that is suitable for recovering process liquid from a feed slurry that predominantly comprises a mixture of the process liquid and solid particles, the apparatus including:
(a) a reservoir suitable for holding the process liquid, a sweep liquid and feed slurry and operating at required pressures, and;
(b) a substantially horizontal filter medium mounted in the reservoir so as to create within the reservoir an upper chamber bounded on its lower side by the filter medium and a lower chamber bounded on its upper side by the filter medium, wherein the filter medium blocks the passage of most or all of the solid particles in the feed slurry from the upper chamber to the lower chamber but allows liquids to flow through it from the upper chamber to the lower chamber, and;
(c) a feed slurry inlet means through which feed slurry enters the upper chamber, and;
(d) a sweep liquid inlet means through which the sweep liquid enters the upper chamber, and;
(e) a filtrate outlet means through which filtrate flows from the lower chamber out of the reservoir, and;
(f) a slurry outlet means through which slurry flows from the upper chamber out of the reservoir, and;
(g) pressure connections and sources of pressure and/or vacuum connected thereto such that in use the pressure in the upper chamber is sufficiently higher than that in the lower chamber so as to cause liquid to flow downwards through the filter medium, and;
(h) an agitator means that agitates a portion of the liquid that is in close proximity to and above the filter medium so as to impede or prevent the excessive accumulation of solid particles on the filter medium, wherein the agitation means is adapted and dimensioned to avoid excessive mixing of the sweep liquid and the process liquid.

14. The apparatus of claim 13 wherein the agitation means includes one or more stirring blades that move in a substantially horizontal plane through at least a portion of the liquid layer that is above and in close proximity to a top surface of the filter medium.

15. An apparatus for recovering one or more non-aqueous process liquids from a feed slurry that comprises one or more non-aqueous process liquids and solid particles; the apparatus comprising:
a) a reservoir which is adapted to accept and hold a sweep liquid and feed slurry, wherein the sweep liquid is less dense than and substantially miscible with the process liquid, wherein the feed slurry comprises a mixture of the process liquid and solid particles, and;
b) a substantially horizontal filter medium within the reservoir which is adapted and dimensioned to allow liquids to flow through it in use while blocking the passage of most or all of the solid particles in the feed slurry through the filter medium, and;
c) a pressurising means which is adapted to provide a pressure difference across the filter medium where a pressure above the filter medium is higher than a pressure acting beneath the filter medium, the pressure difference being sufficient to cause the liquid to flow through the filter medium, thereby drawing an interface region between the sweep liquid layer and the process liquid layer towards the filter medium when the apparatus is in use, and;
d) an agitation means which is adapted to agitate a portion of the liquid that is in close proximity to and above the filter medium so as to impede or prevent excessive accumulation of solid particles on the filter medium, wherein the agitation means is adapted and dimensioned to avoid excessive mixing of the sweep liquid and the process liquid, and;
e) a first outlet means adapted to allow liquid filtrate to exit the reservoir.

16. The apparatus of claim 15 wherein the agitation means includes one or more stirring blades that move in a substantially horizontal plane through at least a portion of the liquid layer that is above and in close proximity to the a top surface of the filter medium.

17. The apparatus of claim 15 further comprising:
f) a second outlet means adapted to allow slurry or sediment formed above the filter medium to exit the reservoir, such slurry or sediment substantially comprising the sweep liquid and the solid particles from the feed slurry.
